(19) United States
(12) Patent Application Publication
(10) Pub. No.: US 2026/0210505 A1
(43) Pub. Date: Jul. 23, 2026

(54) LIGHT GENERATING SYSTEM WITH TRIANGULAR LIGHT GUIDE PANEL

(71) Applicant: SIGNIFY HOLDING B.V., EINDHOVEN (NL)

(72) Inventors: PETER JOHANNES MARTINUS BUKKEMS, DEURNE (NL); JOHANNES PETRUS MARIA ANSEMS, HULSEL (NL); TIES VAN BOMMEL, HORST (NL)

(21) Appl. No.: 19/140,020

(22) PCT Filed: Dec. 5, 2023
(86) PCT No.: PCT/EP2023/084320

§ 371 Date: Jun. 17, 2025

(30) Foreign Application Priority Data
Jan. 3, 2023 (EP) 23150102.4

(51) Int. Cl. F21S 2/00; F21V 7/00; F21V 8/00; F21V 14/02; F21Y 103/10; F21Y 115/10

(52) U.S. Cl. CPC F21S 2/005; F21V 7/005; F21V 7/0091; F21V 14/02; G02B 6/0061; G02B 6/0078; G02B 6/0088; F21V 2200/20; F21Y 2103/10; F21Y 2115/10

(57) ABSTRACT

The invention provides a light generating system (1000) comprising a lighting arrangement (100) of a triangular light guide panel (130) and a light source arrangement (110), wherein: the triangular light guide panel (130) comprises a first triangular face (136) and a second triangular face (139), wherein the triangular light guide panel (130) further comprises a first side face (131), a second side face (132), and a third side face (133), 5 bridging a distance (d1) between the first triangular face (136) and the second triangular face (139), wherein the first side face has a first length (L1); the light source arrangement (110) comprises a plurality of light sources (10) configured in an array (115) aligned with the first side face (131), wherein the light sources (10) are configured to provide light source light (11) having a luminous flux, wherein the light sources (10) comprise solid state light sources; 10 the triangular light guide panel (130) comprises light outcoupling elements (120), wherein the light outcoupling elements (120) are arranged in the triangular light guide panel (130), and/or on the first triangular face (136), and/or on the second triangular face (139); and wherein the light outcoupling elements (120) are configured to facilitate light outcoupling from the triangular light guide panel (130); the light source arrangement (110) and the 15 triangular light guide panel (130) are configured such that in a first operational mode of the light generating system (1000) (a) at least part of the light source light (11) enters the triangular light guide panel (130) via the first side face (131) to provide incoupled light source light (12), wherein the triangular light guide panel (130) is configured to guide the incoupled light source light via total internal reflection, and (b) at least part of the incoupled 20 light source light (12) is coupled out from the triangular light guide panel (130) via the first triangular face (136); a density of the light outcoupling elements (120) increases with increasing normal distance (ND) from the first side face (131); and in the first operational mode, the light source light (11) incident on the first side face (131) has a luminous flux gradient along at least 20% of the first length (L1).

### FIELD OF THE INVENTION

The invention relates to a light generating system comprising a triangular light guide panel. The invention further relates to an indoor space hosting the light generating system.

### BACKGROUND OF THE INVENTION

Light generating systems are known in the art. For instance, US20080037284A1 describes a modular illumination system including light emitting tile modules, each module comprising a light guide substrate, at least one source of illumination optically coupled to a light guiding substrate and interconnection means to connect one light emitting tile module to another light emitting tile module. The interconnection means may include mechanical and/or electrical elements. A plurality of modules may be connected to create an extended continuous extended illuminating system. In one embodiment, the light guiding substrate of one module extends over the source of illumination of an adjacent module. In a further embodiment, the light guiding substrate may be textured to create a patterned area with higher light extraction. In a further embodiment, the source of illumination may be included in a separate electrical member. The illumination sources may include LEDs directed into an edge of the light guiding substrate.

### SUMMARY OF THE INVENTION

A recent trend in general lighting may be to use light guide panels (LGP). A LGP based luminaire typically comprises a light guide arranged between a reflector and a diffuser. LED light typically emitted from a LED strip is coupled into the light guide at an edge and subsequently light guided by total internal reflection till it is coupled out at a major surface of the light guide by using light outcoupling means on or in the light guide, e.g. using a matrix of reflective dots.

Generally, it may be desired that an LGP provides (relatively) uniform illumination from a major surface. The prior art may describe square LGPs with (relatively) uniform illumination. However, for other LGP shapes, such as for triangular LGPs, it may be challenging to provide a uniform illumination and/or a high illumination efficiency. This may limit the application of LGP based luminaires.

Hence, it may be desired to improve the performance and/or functionality of LGP based luminaires.

Hence, it is an aspect of the invention to provide an alternative light generating system, which preferably further at least partly obviates one or more of above-described drawbacks. The present invention may have as object to overcome or ameliorate at least one of the disadvantages of the prior art, or to provide a useful alternative.

According to a first aspect, the invention provides a light generating system (or “system”) comprising a lighting arrangement of a triangular light guide panel and a light source arrangement. In embodiments, the triangular light guide panel may comprise a first triangular face and a second triangular face. Especially, the triangular light guide panel may further comprise a first (rectangular) side face, a second (rectangular) side face, and a third (rectangular) side face. The first side face, second side face and third side face may especially bridge a distance dl between the first triangular face and the second triangular face. In embodiments, the first side face may have a first length L1, especially along an axis of elongation. In further embodiments, the light source arrangement may comprise a plurality of light sources configured in an array, especially wherein the array is aligned with the first side face. In particular, in embodiments, the first side face may be configured in a light-receiving relationship with the light sources, especially in an operational mode of the light generating system (see below). In further embodiments, the light sources may be configured to provide light source light having a luminous flux. The triangular light guide panel may, in embodiments, comprise light outcoupling elements. Especially, the light outcoupling elements may be arranged in the triangular light guide panel, on the first triangular face, and/or on the second triangular face. In particular, the light outcoupling elements may be configured to facilitate light outcoupling from the triangular light guide panel, especially via the first triangular face. In further embodiments, the light source arrangement and the triangular light guide panel may be configured such that in a first operational mode of the light generating system at least part of the light source light enters the triangular light guide panel via the first side face to provide incoupled light source light, especially wherein the triangular light guide panel is configured to guide the incoupled light source light via total internal reflection. Further, the light source arrangement and the triangular light guide panel may be configured such that in the first operational mode of the light generating system at least part of the incoupled light source light is coupled out from the triangular light guide panel via the first triangular face, and especially (also) via the light outcoupling elements. Further, in embodiments, a density of the light outcoupling elements may increase with increasing normal distance from the first side face. In further embodiments, in the first operational mode, the light source light incident on the first side face may have a luminous flux gradient along at least 20% of the first length L1.

Hence, in specific embodiments, the invention may provide a light generating system comprising a lighting arrangement of a triangular light guide panel and a light source arrangement, wherein: the triangular light guide panel comprises a first triangular face and a second triangular face, wherein the triangular light guide panel further comprises a first side face, a second side face, and a third side face, bridging a distance dl between the first triangular face and the second triangular face, wherein the first side face has a first length L1; the light source arrangement comprises a plurality of light sources configured in an array aligned with the first side face, wherein the light sources are configured to provide light source light having a luminous flux; the triangular light guide panel comprises light outcoupling elements, wherein the light outcoupling elements are arranged in the triangular light guide panel, on the first triangular face, and/or on the second triangular face, and wherein the light outcoupling elements are configured to facilitate light outcoupling from the triangular light guide panel; the light source arrangement and the triangular light guide panel are configured such that in a first operational mode of the light generating system (a) at least part of the light source light enters the triangular light guide panel via the first side face to provide incoupled light source light, wherein the triangular light guide panel is configured to guide the incoupled light source light via total internal reflection, and (b) at least part of the incoupled light source light is coupled out from the triangular light guide panel via the first triangular face; a density of the light outcoupling elements increases with increasing normal distance from the first side face; and in the first operational mode, the light source light incident on the first side face has a luminous flux gradient along at least 20% of the first length L1.

With such light generating system, system light may be provided from the triangular light guide panel with a (relatively) uniform (or “homogenous”) luminance and/or a (relatively) high efficiency, such as a uniform luminance with a high efficiency.

The invention may further relate to hinged triangular light guide panels having homogenous luminance and high efficiency. A plurality (e.g. 2) hinged triangular light guide panels may be arranged in a rectangular (e.g. squared) configuration and eventually a plurality of said rectangular configurations may be arranged in a column. An elongated PCB with a plurality of LEDs may typically be arranged at a side which is not hinged. The invention may further relate to flexible connectable light guide panels with hinge structures. For instance, a light generating system may comprise a plurality of luminaires, wherein each luminaire is square or rectangular and comprises two triangular parts each part comprising a LED strip and an LGP (and a reflector at one major surface of said LGP) (and a diffuser at another major surface of said LGP). The two triangular parts may be connected via a hinge located at a diagonal of said luminaire. For instance, at least one side surface of each triangular part, typically opposite sides surfaces of said luminaire, may comprise a connector for mechanically connecting to a further luminaire. Such connector may be a further hinge, for example arranged at an angle of 45 degrees with respect to said hinge.

Hence, the invention may provide a light generating system comprising a lighting arrangement. The lighting arrangement may especially comprise a triangular light guide panel and a light source arrangement.

The term “light guide panel” (also “light guide plate”) may herein refer to a structure configured to guide light, especially light source light, the structure having a plate-like shape, i.e., relatively thin compared to its length and width.

In particular, the lighting arrangement may comprise a triangular light guide panel, i.e., a light guide panel having a first triangular face and a second triangular face, especially wherein the second triangular face is aligned with and arranged opposite of the first triangular face.

The first triangular face (and the second triangular face) may approximate a triangular shape. For instance, the first triangular face (and the second triangular face) may have a triangular shape but may have rounded corners. In specific embodiments, the first triangular face (and the second triangular face) may have a triangular shape.

The term “approximate” and its conjugations herein, such as in “to approximate a shape”, refers to being nearly identical to, especially identical to, the following term, for example nearly identical to a triangle. For example, a triangular face may define a triangle but for a defect. In particular, an object approximating a first shape may herein refer to: a first shape realization encompassing the object, wherein the first shape realization is defined as the smallest encompassing shape of the (2D or 3D, respectively) object wherein the first shape realization has the shape of the first shape, wherein a ratio of the area (volume) of the first shape realization to the area (volume) of the object is ≤1.2, especially ≤1.1, such as ≤1.05, especially ≤1.02. For instance, a triangular face may approximate a triangular shape, wherein the first shape realization may be defined as the smallest encompassing semi-triangular shape of the triangular face, wherein a ratio of the volume of the first shape realization to the volume of the triangular face is ≤1.1, especially, especially ≤1.05, such as ≤1.01, including 1. Further, if the dimensions of the first shape are defined, the term approximate may refer to the object and the first shape being superimposable (in 2D or 3D, respectively) such that an intersection between the object and the first shape covers at least n % of the object and at least n % of the shape, wherein n is at least 90%, such as at least 95%, especially at least 98%, such as at least 99%, including 100%.

In embodiments, the triangular light guide panel may further comprise a first (rectangular) side face, a second (rectangular) side face, and a third (rectangular) side face. The first, second and third side faces, may especially bridge a distance d1 between the first triangular face and the second triangular face. The distance d1 may herein also be referred to as a “thickness” of the triangular light guide panel.

In embodiments, the first side face may have a first length L1, especially a first length L1 along an axis of elongation (of the first side face). In particular, the first side face may have a first length L1 perpendicular to the distance d1 (or “the thickness”), especially wherein L1≥5*d1, such as ≥10*d1, especially ≥20*d1. In further embodiments, L1≤300*d1, such as ≤100*d1.

The triangular light guide panel may especially also have a largest width W_{Max} perpendicular to the first side face, i.e., perpendicular to the first length L1 and to the distance d1. In embodiments, W_{Max} may be selected from the range of 0.1*L1-10*L1, such as from the range of 0.2*L1-5*L1, especially from the range of 0.5*L1-2*L1. In further embodiments, W_{Max} may be selected from the range of 0.8*L1-1.2*L1, such as from the range of 0.9*L1-1.1*L1. In particular, in embodiments, L1 and W_{Max} may be (essentially) equal.

In embodiments, the triangular light guide panel may comprise light outcoupling elements. The light outcoupling elements may be configured to facilitate light outcoupling from the triangular light guide panel, especially of (incoupled) light source light. In embodiments, (at least part of) the light outcoupling elements may be arranged in the triangular light guide panel, and/or on the first triangular face, and/or on the second triangular face, especially (at least part of) the light outcoupling elements may be arranged in the triangular light guide panel, or especially (at least part of) the light outcoupling elements may be arranged on the first triangular face, or especially (at least part of) the light outcoupling elements may be arranged on the second triangular face. Hence, the light outcoupling elements may be distributed on and/or in the light guide. Practically, it may be convenient for the light outcoupling elements to be arranged on the first triangular face and/or on the second triangular face, especially (at least) on the second triangular face.

In embodiments, the light outcoupling elements may especially comprise reflective dots and/or scattering features. In such embodiments, the light outcoupling elements may especially be arranged on the second triangular face. They may especially be applied via printing or dispensing or laser modification. The light outcoupling elements may especially be arranged on the second triangular face such that a substantial part of the incoupled light is outcoupled from the lightguide panel via the first triangular face.

In embodiments, the light source arrangement may comprise (a plurality of) light sources. The light sources may especially be configured in an array, such as in an array aligned with the first side face. In embodiments, the array may comprise a single row of light sources, i.e., the array may comprise a 1×N array. In further embodiments, the array may comprise multiple rows of light sources, i.e., the array may comprise an M×N array. For instance, in embodiments, the light sources may comprise LED light sources, wherein the LED light sources are arranged in a LED array. In embodiments, the light sources may be arranged at a constant pitch, especially along the first length. However, in further embodiments, the light sources may be arranged at a varying pitch, especially along the first length. The light sources may especially be configured to provide light source light having a luminous flux. In particular, in embodiments, the light sources may be configured to provide the light source light to the first side face, i.e., the first side face may be configured in a light-receiving relationship with the light sources.

Especially, the array of light sources is an elongated array. The light sources may be configured to provide the light source light to the first side face, wherein at least 70%, such as at least 80%, more especially at least 85% of an area of the first side face receives the light source light.

In embodiments, the light sources may comprise solid state light sources, especially light emitting diodes (LEDs). Hence, in embodiments, the light source arrangement may comprise a (a plurality of) LEDs, especially wherein the LEDs are configured in an array, such as in an array aligned with the first side face.

The lighting arrangement, especially the light source arrangement and the triangular light guide panel, may be configured such that in a first operational mode of the light generating system at least part of the light source light enters the triangular light guide panel via the first side face to provide incoupled light source light, especially wherein the triangular light guide panel is configured to guide the incoupled light source light via total internal reflection. Further, in embodiments, the lighting arrangement, especially the light source arrangement and the triangular light guide panel, may be configured such that in a first operational mode of the light generating system at least part of the incoupled light source light is coupled out from the triangular light guide panel via the first triangular face, and especially via the light outcoupling elements. Thereby, during the first operational mode, the light generating system may be configured to provide system light from the first triangular face, especially wherein the system light comprises (at least part of) the outcoupled light source light.

Hence, the light generating system may have a (first) operational mode. In particular, the light generating system may comprise a control system, wherein the control system has an operational mode. The term “operational mode” may also be indicated as “controlling mode”. The system, or apparatus, or device (see further also below) may execute an action in a “mode” or “operational mode” or “mode of operation”. Likewise, in a method an action, stage, or step may be executed in a “mode” or “operation mode” or “mode of operation”. This does not exclude that the system, or apparatus, or device may also be adapted for providing another operational mode, such as a second operational mode, or a plurality of other operational modes. Likewise, this does not exclude that before executing the mode and/or after executing the mode one or more other modes may be executed. However, in embodiments, a control system (see further also below) may be available, that is adapted to provide at least the operational mode. Would other modes be available, the choice of such modes may especially be executed via a user interface, though other options, like executing a mode in dependence of a sensor signal or a (time) scheme, may also be possible. The operational mode may in embodiments also refer to a system, or apparatus, or device, that can only operate in a single operational mode (i.e. “on”, without further tunability).

Hence, in embodiments, the light generating system may comprise a control system. The control system may especially be configured to control the light sources.

The term “controlling” and similar terms herein may especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system. The control system and the element may thus at least temporarily, or permanently, functionally be coupled. The element may comprise the control system. In embodiments, the control system and the element may not be physically coupled. Control can be done via wired and/or wireless control. The term “control system” may also refer to a plurality of different control systems, which especially are functionally coupled, and of which e.g. one master control system may be a control system and one or more others may be slave control systems.

As mentioned above, in embodiments, the triangular light guide panel may comprise light outcoupling elements.

In further embodiments, a density of the light outcoupling elements may increase with increasing normal distance from the first side face, especially along at least 80% of a (local) width of the triangular light guide panel, such as along at least 90%. The increase in density of the light outcoupling with increasing normal distance from the first side face may result in an increase in the proportion of light source light that gets outcoupled from the triangular light guide panel with increasing normal distance from the first side face. Thereby, the increasing density of the light outcoupling elements can account for the decreasing amount of light arriving with increasing normal distance to the first side face (as with increasing distance more and more light has already been outcoupled).

The term “density” in the phrase “density of the light outcoupling elements” may herein refer to a proportion of an area (or volume) covered by (or taken up by) the light outcoupling elements. Hence, the increase of the light outcoupling elements with increasing normal distance to the first side face may be realized via an increase size of the light outcoupling elements and/or by an increased number of the light outcoupling elements.

Hence, in embodiments, the size of the light outcoupling elements may increase with increasing normal distance from the first side face, especially with a constant or increasing number of light outcoupling elements with increasing normal distance from the first side face.

In further embodiments, the number of the light outcoupling elements may increase with increasing normal distance from the first side face, especially with a constant or increasing size of light outcoupling elements with increasing normal distance from the first side face.

In particular, with reference to embodiments wherein (at least part of) the light outcoupling elements are arranged on the second triangular face (or on the first triangular face), the proportion of the area of the second triangular face covered by the light outcoupling elements may increase with increasing normal distance to the first side face. Further, in reference to embodiments wherein the light outcoupling elements are arranged in the triangular light guide panel, a proportion of the volume of the triangular light guide panel taken up by the light outcoupling elements may increase with increasing normal distance to the first side face.

The phrase “normal distance to the first side face” refers to the Euclidian distance between a point and the first side face, i.e., a distance measured between the first side face and the point along a line perpendicular to the first side face.

In specific embodiments, the density of the light outcoupling elements may vary via one or more of a size of the light outcoupling elements or a number of the light outcoupling elements, especially wherein (at least part of) the light outcoupling elements are arranged on the second triangular face, and especially wherein the at least part of the incoupled light source light is coupled out from the triangular light guide panel via the light outcoupling elements and the first triangular face.

In further embodiments, especially in the first operational mode, the light source light incident on the first side face may have a luminous flux gradient along at least 10% of the first length L1, such as along at least 20% of the first length L1. The term “luminous flux gradient” may herein refer to an increase or a decrease in the luminous flux. Hence, the phrase “a luminous flux gradient along at least 10% of the first length L1” herein refers to the luminous flux increasing (or decreasing) along at least 10% of the first length L1. In further embodiments, especially in the first operational mode, the light source light incident on the first side face may have a luminous flux gradient along at least 30% of the first length L1, such as along at least 40% of the first length L1. In specific embodiments, especially in the first operational mode, the light source light incident on the first side face may have a luminous flux gradient along 30-50% of the first length L1.

The luminous flux gradient may be an increasing gradient or a decreasing gradient. However, there may also be two or more gradients, such as up to about four gradients, like two gradients. Hence, in embodiments two gradients may have mutual maximum, somewhere between larger than 0>L1 and smaller than L1.

In further embodiments, especially in the first operational mode, the light source light incident on the first side face may have two luminous flux gradients along at maximum 100% of the first length L1, such as along at least 30%, more especially at least 40% of the first length L1. In further embodiments, especially in the first operational mode, the light source light incident on the first side face may have two luminous flux gradients along at most 100%, such as at most about 90%, like at most 80% of the first length L1, such as along at most 70% of the first length L1. In specific embodiments, especially in the first operational mode, the light source light incident on the first side face may have two luminous flux gradient along 30-100% of the first length L1, such as 30-100%, like 40-100%, like in specific embodiments 40-90% of the first length L1, like at least 50% of L1.

In such embodiments, the luminous flux gradient may be varied via one or more of varying pitch between light sources in the array and varying flux output of light sources in the array. For instance, along the luminous flux gradient, a pitch between the light sources may be increasing (or decreasing) between successively arranged light sources along the first length L1. Additionally or alternatively, along the luminous flux gradient, especially in the operational mode, a flux output of the light sources may increase (or decrease) between successively arranged light sources along the first length L1.

In embodiments, luminous flux gradient, such as along the 20% of the first length L1, a plurality of light sources, especially LEDs, may be arranged providing the light source light, e.g. at least 3 LEDs or at least 5 LEDs. Hence, the luminous flux gradient may be provided by the combined light source light of multiple light sources, such as of multiple LEDs, especially at least 3 light sources, such as at least 5 light sources.

For instance, in embodiments, for at least n light sources successively arranged along the first length L1 applies that a light source distance between each set of two successively arranged light sources (of the n light sources) increases along a first direction (parallel to the first length L1). Similarly, in further embodiments, in the operational mode, for at least n light sources successively arranged along the first length L1 applies that the flux output successively increases along the n light sources. In embodiments, n may be selected from the range of 4-100, such as from the range of 10-70, especially from the range of 20-60. In further embodiments, n may be at least 5, such as at least 10.

Hence, in embodiments a light source pitch p, such as an LED pitch, in the array may vary along the first length L1. In particular, the light source pitch p may vary along the first length L1 to provide the luminous flux gradient.

In further embodiments, in the first operational mode, the light generating system may be configured to vary a current provided to the light sources along the first length L1, especially to (have the light sources) provide the luminous flux gradient.

The luminous flux gradient may (at least partially) account for a varying width W1 of the triangular light guide panel, i.e., the luminous flux received by the first side face may generally increase with increasing width along the first length L1. However, in view of reflection of the light source light at the second and third side faces (see also below), the luminous flux may beneficially also decrease towards the extremities of the first side face, even if the width W1 is still increasing. In particular, the luminous flux variation of the light source light on the first side face may result in efficient generation of system light.

In further embodiments, along the first length L1 the luminous flux may vary according to a unimodal distribution. Hence, a plot of the luminous flux received by the first side face vs the position along the first length L1 may resemble a unimodal distribution, i.e., a distribution with a single local maximum. In particular, in embodiments, the luminous flux, and especially the approximated unimodal distribution, may have a peak positioned between the second side face and a central position along the first length L1. In further embodiments, the first side face may have a (first) corner shared with the third side face, and the luminous flux, especially the unimodal distribution, may be skewed towards the (first) corner, i.e., the unimodal distribution may have a longer tail towards the (first) corner than towards a second corner shared between the first side face and the second side face.

Hence, a peak of the unimodal distribution may be positioned between the second side face and a central position along the first length L1.

In particular, in embodiments, a peak (or “maximum position”) of the unimodal distribution may be arranged at a distance d2 from the second side face, especially from a second corner arranged between the first side face and the second side face, wherein d2 is selected from the range of 0.1*L1-0.48*L1, such as from the range of 0.2*L1-0.45*L1.

In embodiments, the first side face and the third side face may be arranged at a (first) angle α₁₃, and the first side face and the second side face may be arranged at a (second) angle α₁₂. Especially, α₁₂≥α₁₃, such as >α₁₃. In further embodiments, α₁₃ may be selected from the range of 10°-90°, such as from the range of 30°-60°, especially from the range of 40°-50°. Hence, in embodiments, α₁₃ may be <90, such as ≤60°. In embodiments, α₁₃ may especially be (about) 45°. In further embodiments, α₁₂ may be selected from the range of 30°-130°, such as from the range of 50°-120°, especially from the range of 70°-110°, such as from the range of 80°-100°. In particular, in embodiments, α₁₂ may be (about) 90°. Hence, in embodiments, the triangular light guide panel may have a right angle between the first side face and the second side face. Further, in embodiments, the second side face and the third side face may be arranged at a (third) angle α₂₃, especially wherein α₁₂≥α₂₃. In further embodiments, α₂₃ may be selected from the range of 10°-90°, such as from the range of 30°-60°, especially from the range of 40°-50°. Hence, in embodiments, α₁₃ may be <90, such as ≤60°. In embodiments, α₂₃ may especially be (about) 45°.

Hence, in embodiments, α₁₃ and α₂₃ may be the same angle, i.e., in embodiments the triangular light guide panel may be shaped according to an isosceles triangle. In further embodiments, α₁₂ may be 90°and α₁₃ and α₂₃ may both be 45°, i.e., in embodiments the triangular light guide panel may be shaped according to an isosceles right triangle.

In further embodiments, each of α₁₂, α₁₃, and α₂₃ is ≤90°. Two of such triangular light guide panels may be conveniently combined (via respective hinge arrangements; see below) to provide a rectangular shape, which may be practically convenient, especially when providing a hinge arrangement with more than two triangular light guide panels.

In further embodiments, each of α₁₂, α₁₃, and α₂₃ is ≥10°, such as ≥30°.

In further embodiments, the second side face may have a second length L2 (along a respective second axis of elongation), wherein 0.5≤L1/L2≤2, especially 0.7≤L1/L2≤1.5. In further embodiments, 0.9≤L1/L2≤1.1, such as 0.98≤L1/L2≤1.02, especially L1=L2.

In further embodiments, the third side face may have a third length L3, especially wherein L3>L1, such as L3≥1.1*L1, especially ≥1.2*L1, such as ≥1.4*L1. In further embodiments, L3≤1.6*L1, such as ≤1.5*L1, such as ≤1.41*L1.

The light generating system may be configured to (essentially) only provide system light from the first triangular face. Hence, the light generating system, especially the triangular light guide panel, may comprise one or more reflectors configured to reflect light source light (back) into the triangular light guide panel.

In particular, the light generating system, especially the triangular light guide panel may comprise a (second) side face reflector, especially wherein the (second) side face reflector is arranged downstream of the second side face, and wherein the side face reflector is configured to reflect light source light, especially to reflect light source light (back) into the triangular light guide panel (at the second side face). In particular, the (second) side face reflector may be configured to reflect at least part of the light source light that has escaped from the (second) side face back into the triangular light guide panel (via the (second) side face).

In particular, the presence of the (second) side face reflector and the (third) side face reflector may substantially improve the efficiency of the light generating system.

In further embodiments, the light generating system, especially the triangular light guide panel, may comprise a triangular face reflector, especially wherein the triangular face reflector is arranged downstream of the second triangular face, and wherein the triangular face reflector is configured to reflect light source light, especially to reflect light source light (back) into the triangular light guide panel (at the second triangular face). In this way, essentially all light source light outcoupled from the triangular light guide panel will escape via the first triangular face. Or, in other words, essentially all light escaping from the system may have escaped from the triangular light guide panel via the first triangular face.

In further embodiments, the light generating system, especially the triangular light guide panel may comprise a (third) side face reflector, especially wherein the side face reflector is arranged downstream of the third side face, and wherein the side face reflector is configured to reflect light source light, especially to reflect light source light (back) into the triangular light guide panel (at the third side face). In particular, the (third) side face reflector may be configured to reflect at least part of the light source light that has escaped from the (third) side face back into the triangular light guide panel (via the (third) side face).

In particular, the one or more reflectors, especially (at least) the second side face reflector, or especially (at least) the third side face reflector, or especially (at least) the triangular face reflector, may have a reflectivity for the light source light of at least 70%, such as at least 80%, especially at least 90%, such as at least 95%, including 100%.

In embodiments, the density of the light outcoupling elements may (also) vary in a cross-section parallel to the first side face, i.e., the density of the light outcoupling elements may (also) vary in a direction parallel to the first side face.

Due to reflection of light source light at the third side face, such as due to a third side face reflector, there may be a locally elevated level of light source light in the proximity of the third side face. Hence, in embodiments, the density of the light outcoupling elements may decrease in a direction parallel to the first side face with decreasing distance to the third side face. Thereby, with decreasing distance to the third side face (in a direction parallel to the first side face), the proportion of light source light outcoupled (via the light outcoupling elements) may decrease, thereby accounting for the locally elevated quantity of light source light.

Similarly, especially in embodiments wherein α₁₂<90°, the density of the light outcoupling elements may decrease in a direction parallel to the first side face with decreasing distance to the second side face. Thereby, the light generating system may account for a locally elevated quantity of light source light due to reflection of light source light at the second side face.

Hence, in embodiments, the density of the light outcoupling elements may increase with increasing normal distance to the first side face, and may decrease with decreasing distance to the third side face (and/or the second side face) in a direction parallel to the first side face. Such a variation in dot density may substantially improve the uniformity (or “homogeneity”) of the light source light outcoupled via the first triangular face.

In particular, in embodiments, a luminous flux of outcoupled light source light (outcoupled via the first triangular face) may vary within 20% of an average value of the luminous flux of the outcoupled light source light, averaged over light source light outcoupled via the first triangular face, such as within 10% of the average value, especially within 3% of the average value.

In further embodiments, the light generating system, especially the triangular light guide panel, may comprise a diffuser. The diffuser may especially be arranged downstream from the first triangular face. In particular, in embodiments, the triangular light guide panel may be arranged (or “sandwiched”) between a diffuser (arranged at the side of the first triangular face) and a triangular reflector (arranged at the side of the second triangular face).

According to optical modelling a triangular lightguide cut from a square lightguide with only the luminous flux gradient may result in a (i) high efficiency (~70%) but (ii) (relatively) poor homogenous luminance. Further, if the density of light outcoupling elements is provided as described herein (increasing with normal distance to first side face and decreasing with decreasing distance to third side face parallel to first side face), but with constant luminous flux, then a reasonable homogenous luminance is obtained, but with a low efficiency. Surprisingly, the combination of these approaches provides both high efficiency and homogenous luminance. In particular, the uniformity of the luminance is higher with the combined approach than with solely the variation in density of light outcoupling elements.

Hence, in embodiments, the light generating system may comprise a (third) side face reflector, wherein the side face reflector is arranged downstream of the third side face, and wherein the side face reflector is configured to reflect light source light (back into the triangular light guide panel), wherein an angle α₁₃ between the first side face and the third side face is selected from the range of <90°, such as ≤60°, and wherein the density of the light outcoupling elements decreases in a direction parallel to the first side face with decreasing distance to the third side face.

In particular, the change in density of the light outcoupling elements may beneficially (for lighting uniformity) be higher at a closer proximity to the third side face (or to the second side face). For instance, in embodiments, the triangular light guide panel may have an outcoupling element density pattern along a cross-section of the triangular light guide panel, especially wherein the density of outcoupling elements along the cross-section are according to the outcoupling element density pattern, and especially wherein the cross-section is parallel to the first side face. The outcoupling element density pattern may have a length L_{d} parallel to the first side face. In particular, the length L_{d} may be equal to the length (parallel to the first side face) of the triangular light guide panel in the cross-section. Further, the outcoupling element density pattern may comprise a first pattern part and a second pattern part, especially wherein the first pattern part is arranged (directly) between the third side face and the second pattern part. In further embodiments, the first pattern part may have a first pattern length L_{P1}, especially wherein 0.02≤L_{P1}/L_{d}≤0.3, such as 0.03≤L_{P1}/L_{d}≤0.2, especially 0.05≤L_{P1}/L_{d}≤0.1. In the first pattern part the density of outcoupling elements may increase (relatively) quickly in a direction away from the third side face, such as by at least 10%, especially by at least 20%, such as by at least 30%. Hence, in embodiments, the density of outcoupling elements in the first pattern part close to the second pattern part may be at least 10% higher than the density in the first pattern part close to the third side face. In further embodiments, the second pattern part may have a second pattern length L_{P2}, wherein 0.05≤L_{P2} /L_{d}≤0.8, such as 0.1≤L_{P2}/L_{d}≤0.5, especially 0.2≤L_{P2}/L_{d}≤0.4. In particular, in embodiments, L_{P2}>L_{P1}, such as L_{P2}≥1.5*L_{P1}, especially L_{P2}≥2*L_{P1}. Further, in the second pattern part the density of outcoupling elements may especially increases by 2-20% in a direction away from the third side face, such as by 5%-15%, especially by 8%-12%. Hence, the first pattern part may be shorter than the second pattern part, but the increase in density of outcoupling elements (in a direction parallel to the first side face and away from the third side face) may be larger in the first pattern part than in the second pattern part.

In further embodiments, the outcoupling element density pattern may further comprise a third pattern part, especially wherein the third pattern part abuts the second pattern part, i.e., especially wherein the second pattern part is arranged (directly) between the first pattern part and the third pattern part. In such embodiments, the third pattern part may have a third pattern length L_{P3}, especially wherein 0.1≤L_{P3}/L_{d}≤0.9, such as 0.3≤L_{P3}/L_{d}≤0.8, especially 0.4≤L_{P3}/L_{d}≤0.6. In particular, in the third pattern part the density of outcoupling elements may vary less than 15% from an average density of outcoupling elements in the third pattern part, such as less than 10%, especially less than 5%, such as less than 3%.

Hence, along the cross-section, the density of the light outcoupling elements in the outcoupling element density pattern may initially increase (relatively) rapidly in a direction away from the third side face along the first pattern part, may subsequently increase (relatively) slowly in a direction away from the third side face in the second pattern part, and may be (essentially) stable in the third pattern part.

In embodiments, the length L_{d} may especially be the length (parallel to the first side face) of the triangular light guide panel in the cross-section. In further embodiments, the length L_{d} may be 30%-70% of the length (parallel to the first side face) of the triangular light guide panel in the cross-section, such as 40%-60%.

As the triangular light guide panel has a triangular shape, the triangular light guide panel may have a varying width W perpendicular to the first side face. In embodiments, along the first length L1 the lighting arrangement may be sectioned into a plurality of sections. The sections may especially be defined between one or more cross-sections perpendicular to the first side face and perpendicular to the first triangular face.

In embodiments, the plurality of sections include a first section and a second section, especially wherein the triangular light guide panel has a first average width W1 in the first section and a second average width W2 in the second section, wherein W1>W2.

In further embodiments, in the operational mode the light sources are configured to provide light source light having a first luminous flux F1 to the first section and light source light having a second luminous flux F2 to the second section, wherein F1>F2. Hence, in embodiments, the wider section may receive a higher luminous flux.

In further embodiments, along a first width range W′, the triangular light guide panel has a first density D1 of light outcoupling elements in the first section and a second density D2 of light outcoupling elements in the second section, wherein D1>D2. In particular, the first width range W′ may in the second section be arranged proximal to the third side face. Hence, in the first width range W′, the density of light outcoupling elements may be relatively low in the second section.

In embodiments, the first width range 0.03≤W′/Wₘₐₓ≤0.3, such as 0.05≤W′/Wₘₐₓ≤0.2, especially 0.08≤W′/Wₘₐₓ≤0.1.

In further embodiments, within each section (of the plurality of sections) a density of light outcoupling elements may increase with increasing normal distance to the light source arrangement, especially along at least 80% of the width of the section, such as along at least 90% of the width of the section.

As mentioned above, the triangular light guide panel of the invention may be particularly suited for being combined with a hinge arrangement. In particular, in embodiments, the lighting arrangement may comprise a hinge arrangement, wherein the hinge arrangement is arranged at the first side face, at the second side face, or at the third side face, especially at the first side face, or especially at the second side face or at the third side face, such as at the second side face, or such as at the third side face. Practically, it may be convenient for the hinge arrangement and the array to be arranged at different side faces. Hence, in embodiments, the hinge arrangement may especially be arranged at the second and/or third side face. The hinge arrangement may especially be configured for functional coupling to a second hinge arrangement of a second lighting arrangement. For instance, the hinge arrangement may comprise female and male parts configured for coupling to male and female parts of a second hinge arrangement. Thereby, the two lighting arrangement may be arranged at an angle relative to one another via their hinge arrangements.

It may be desirable to connect more than two lighting arrangement via hinge arrangements. Hence, in embodiments, the lighting arrangement may comprise two hinge arrangements, wherein the two hinge arrangement are arranged at two different side faces (of the respective triangular light guide panel), especially on the second side face and on the third side face.

In further embodiments, the lighting arrangement may comprise three hinge arrangements, wherein each hinge arrangement is arranged at a (respective) different side face of the triangular light guide panel.

Hence, in embodiments, the light generating system may comprise a plurality of lighting arrangements, especially including a first lighting arrangement and a second lighting arrangement. In embodiments a first hinge arrangement may be arranged at the third side face of the first lighting arrangement, and a second hinge arrangement may be arranged at the third side face of the second lighting arrangement, especially wherein the first hinge arrangement is functionally coupled, especially physically coupled, to the second hinge arrangement. In particular, in embodiments, the first hinge arrangement may be functionally coupled, especially physically coupled, to the second hinge arrangement such that the first lighting arrangement and the second lighting arrangement are in a hinge configuration, especially wherein the hinged configuration allows controlling a hinge angle between the first lighting arrangement and the second lighting arrangement. Further, in embodiments, the first hinge arrangement may be functionally coupled, especially physically coupled, to the second hinge arrangement such that the first lighting arrangement and the second lighting arrangement are hingely connected and can be folded with respect to each other. In particular, in further embodiments, the first lighting arrangement and the second lighting arrangement may each comprise a triangular light guide panel having a shape according to an isosceles right triangle (with a right second angle α₁₂). Thereby, the first lighting arrangement and the second lighting arrangement together may approximate, especially define, a square shape.

In further embodiments, the first hinge arrangements may be arranged on the first side face or the second side face of the first lighting arrangement, and the second hinge arrangement may be arranged on the first side face or the second side face of the second lighting arrangement.

In further embodiments, the first lighting arrangement and the second lighting arrangement may be arranged at a hinge angle αₕ, especially wherein the hinge angle αₕ is selected from the range of 0-90°, such as from the range of 5°-60°, especially from the range of 10°-40°. The hinge angle αₕ may especially refer to the angle between the triangular light guide panels at the (respective) hinge arrangements. In embodiments, the hinge arrangement may comprise a flexible part, e.g. a polymer part, to facilitate tilting the hinge arrangement.

In further embodiments, the plurality of lighting arrangements may comprise at least four lighting arrangements coupled via (respective) hinge arrangements, i.e., the four lighting arrangement are all coupled together via hinge arrangements. For instance, if the four lighting arrangements are defined as A, B, C, and D, the couplings between the four lighting arrangement may comprise: A-B, B-C, and C-D, wherein “A-B” indicates a physical coupling between lighting arrangement A and lighting arrangement B via respective hinge arrangements. Alternatively, the couplings may, for instance, comprise: A-B, B-C, C-D, and A-D. Yet alternatively, the coupling may, for instance, comprise: A-B, A-C, and A-D.

In further embodiments, for at least two sets of two functionally coupled, especially physically coupled, hinge arrangements applies that (a) one of the two functionally coupled hinge arrangements is arranged at the first side face or the second side face of one of the plurality of lighting arrangements and (b) another of the two functionally coupled hinge arrangements is arranged at the first side face or the second side face of another of the plurality of lighting arrangements.

The terms “upstream” and “downstream” relate to an arrangement of items or features relative to the propagation of the light from a light generating means (here especially the light sources), wherein relative to a first position within a beam of light from the light generating means, a second position in the beam of light closer to the light generating means is “upstream”, and a third position within the beam of light further away from the light generating means is “downstream”. It will be clear to the person skilled in the art that a reflector configured to reflect light from a space back into the space is thus both downstream and upstream of the space relative to the propagation of the light.

The term “light source” may in principle relate to any light source known in the art. It may be a conventional (tungsten) light bulb, a low pressure mercury lamp, a high pressure mercury lamp, a fluorescent lamp, an LED (light emissive diode). In a specific embodiment, the light source comprises a solid state LED light source (such as an LED or laser diode (or “diode laser”)). The term “light source” may also relate to a plurality of light sources, such as 2-2000 (solid state) LED light sources. Hence, the term LED may also refer to a plurality of LEDs. Further, the term “light source” may in embodiments also refer to a so-called chip-on-board (COB) light source. The term “COB” especially refers to LED chips in the form of a semiconductor chip that is neither encased nor connected but directly mounted onto a substrate, such as a PCB. Hence, a plurality of light emitting semiconductor light source may be configured on the same substrate. In embodiments, a COB is a multi LED chip configured together as a single lighting module.

The term “light source” may also refer to a chip scaled package (CSP). A CSP may comprise a single solid state die with provided thereon a luminescent material comprising layer. The term “light source” may also refer to a midpower package. A midpower package may comprise one or more solid state die(s). The die(s) may be covered by a luminescent material comprising layer. The die dimensions may be equal to or smaller than 2 mm, such as in the range of e.g. 0.2-2 mm. Hence, in embodiments the light source comprises a solid state light source. Further, in specific embodiments, the light source comprises a chip scale packaged LED. Herein, the term “light source” may also especially refer to a small solid state light source, such as having a mini size or micro size. For instance, the light sources may comprise one or more of mini LEDs and micro LEDs. Especially, in embodiment the light sources comprise micro LEDs or “microLEDs” or “μLEDs”. Herein, the term mini size or mini LED especially indicates to solid state light sources having dimensions, such as die dimension, especially length and width, selected from the range of 100 μm-1 mm. Herein, the term μ size or micro LED especially indicates to solid state light sources having dimensions, such as die dimension, especially length and width, selected from the range of 100 μm and smaller.

The light source may have a light escape surface. Referring to conventional light sources such as light bulbs or fluorescent lamps, it may be an outer surface of a glass or a quartz envelope. For LED's it may for instance be the LED die, or when a resin is applied to the LED die, the outer surface of the resin. In principle, it may also be the terminal end of a fiber. The term escape surface especially relates to that part of the light source, where the light actually leaves or escapes from the light source. The light source is configured to provide a beam of light. This beam of light (thus) escapes from the light exit surface of the light source.

Likewise, a light generating device may comprise a light escape surface, such as an end window. Further, likewise a light generating system may comprise a light escape surface, such as an end window.

The term “light source” may refer to a semiconductor light-emitting device, such as a light emitting diode (LEDs), a resonant cavity light emitting diode (RCLED), a vertical cavity laser diode (VCSELs), an edge emitting laser, etc. The term “light source” may also refer to an organic light-emitting diode (OLED), such as a passive-matrix (PMOLED) or an active-matrix (AMOLED). In a specific embodiment, the light source comprises a solid-state light source (such as an LED or laser diode). In an embodiment, the light source comprises an LED (light emitting diode). The terms “light source” or “solid state light source” may also refer to a superluminescent diode (SLED).

The term LED may also refer to a plurality of LEDs.

The term “light source” may also relate to a plurality of (essentially identical (or different)) light sources, such as 2-2000 solid state light sources. In embodiments, the light source may comprise one or more micro-optical elements (array of micro lenses) downstream of a single solid-state light source, such as an LED, or downstream of a plurality of solid-state light sources (i.e. e.g. shared by multiple LEDs). In embodiments, the light source may comprise an LED with on-chip optics. In embodiments, the light source comprises pixelated single LEDs (with or without optics) (offering in embodiments on-chip beam steering).

In embodiments, the light source may be configured to provide primary radiation, which is used as such, such as e.g. a blue light source, like a blue LED, or a green light source, such as a green LED, and a red light source, such as a red LED. Such LEDs, which may not comprise a luminescent material (“phosphor”) may be indicated as direct color LEDs.

In other embodiments, however, the light source may be configured to provide primary radiation and part of the primary radiation is converted into secondary radiation. Secondary radiation may be based on conversion by a luminescent material. The secondary radiation may therefore also be indicated as luminescent material radiation. The luminescent material may in embodiments be comprised by the light source, such as an LED with a luminescent material layer or dome comprising luminescent material. Such LEDs may be indicated as phosphor converted LEDs or PC LEDs (phosphor converted LEDs). In other embodiments, the luminescent material may be configured at some distance (“remote”) from the light source, such as an LED with a luminescent material layer not in physical contact with a die of the LED. Hence, in specific embodiments the light source may be a light source that during operation emits at least light at wavelength selected from the range of 380-470 nm. However, other wavelengths may also be possible. This light may partially be converted by the luminescent material.

In embodiments, the light generating device may comprise a luminescent material. In embodiments, the light generating device may comprise a PC LED. In other embodiments, the light generating device may comprise a direct LED (i.e. no phosphor). In embodiments, the light generating device may comprise a laser device, like a laser diode. In embodiments, the light generating device may comprise a superluminescent diode. Hence, in specific embodiments, the light source may be selected from the group of laser diodes and superluminescent diodes. In other embodiments, the light source may comprise an LED.

The light source may especially be configured to generate light source light having an optical axis (O), (a beam shape,) and a spectral power distribution. The light source light may in embodiments comprise one or more bands, having band widths as known for lasers.

The term “light source” may (thus) refer to a light generating element as such, like e.g. a solid state light source, or e.g. to a package of the light generating element, such as a solid state light source, and one or more of a luminescent material comprising element and (other) optics, like a lens, a collimator. A light converter element (“converter element” or “converter”) may comprise a luminescent material comprising element. For instance, a solid state light source as such, like a blue LED, is a light source. A combination of a solid state light source (as light generating element) and a light converter element, such as a blue LED and a light converter element, optically coupled to the solid state light source, may also be a light source (but may also be indicated as light generating device). Hence, a white LED is a light source (but may e.g. also be indicated as (white) light generating device).

The term “light source” herein may also refer to a light source comprising a solid state light source, such as an LED or a laser diode or a superluminescent diode.

The term “light source” may (thus) in embodiments also refer to a light source that is (also) based on conversion of light, such as a light source in combination with a luminescent converter material. Hence, the term “light source” may also refer to a combination of an LED with a luminescent material configured to convert at least part of the LED radiation, or to a combination of a (diode) laser with a luminescent material configured to convert at least part of the (diode) laser radiation.

In embodiments, the term “light source” may also refer to a combination of a light source, like an LED, and an optical filter, which may change the spectral power distribution of the light generated by the light source. Especially, the term “light generating device” may be used to address a light source and further (optical components), like an optical filter and/or a beam shaping element, etc.

The phrases “different light sources” or “a plurality of different light sources”, and similar phrases, may in embodiments refer to a plurality of solid-state light sources selected from at least two different bins. Likewise, the phrases “identical light sources” or “a plurality of same light sources”, and similar phrases, may in embodiments refer to a plurality of solid-state light sources selected from the same bin.

The term “solid state light source”, or “solid state material light source”, and similar terms, may especially refer to semiconductor light sources, such as a light emitting diode (LED), a laser diode, or a superluminescent diode. Hence, in embodiments, the light generating system, especially the light source arrangement, comprises an array of light emitting diodes.

The light generating system may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, (outdoor) road lighting systems, urban lighting systems, green house lighting systems, horticulture lighting, digital projection, or LCD backlighting. The light generating system (or luminaire) may be part of or may be applied in e.g. optical communication systems or disinfection systems.

In embodiments, the light sources may be configured to provide white light source light.

The term “white light”, and similar terms, herein, is known to the person skilled in the art. It may especially relate to light having a correlated color temperature (CCT) between about 1800 K and 20000 K, such as between 2000 and 20000 K, especially 2700-20000 K, for general lighting especially in the range of about 2000-7000 K, such as in the range of 2700 K and 6500 K. In embodiments, e.g. for backlighting purposes, or for other purposes, the correlated color temperature (CCT) may especially be in the range of about 7000 K and 20000 K. Yet further, in embodiments the correlated color temperature (CCT) is especially within about 15 SDCM (standard deviation of color matching) from the BBL (black body locus), especially within about 10 SDCM from the BBL, even more especially within about 5 SDCM from the BBL.

In specific embodiments, the correlated color temperature (CCT) may be selected from the range of 6000-12000 K, like selected from the range of 7000-12000 K, like at least 8000 K. Yet further, in embodiments the correlated color temperature (CCT) may be selected from the range of 6000-12000 K, like selected from the range of 7000-12000 K, in combination with a CRI of at least 70.

In an embodiment, the light source may also provide light source light having a correlated color temperature (CCT) between about 5000 and 20000 K, e.g. direct phosphor converted LEDs (blue light emitting diode with thin layer of phosphor for e.g. obtaining of 10000 K). Hence, in a specific embodiment the light source is configured to provide light source light with a correlated color temperature in the range of 5000-20000 K, even more especially in the range of 6000-20000 K, such as 8000-20000 K. An advantage of the relative high color temperature may be that there may be a relatively high blue component in the light source light.

In embodiments, the light sources may be configured to provide visible light source light, i.e., light source light comprising visible light.

The terms “visible”, “visible light” or “visible emission” and similar terms refer to light having one or more wavelengths in the range of about 380-780 nm. Herein, UV may especially refer to a wavelength selected from the range of 190-380 nm, such as 200-380 nm.

The terms “light” and “radiation” are herein interchangeably used, unless clear from the context that the term “light” only refers to visible light. The terms “light” and “radiation” may thus refer to UV radiation, visible light, and IR radiation. In specific embodiments, especially for lighting applications, the terms “light” and “radiation” refer to (at least) visible light.

As described above, in embodiments, the light generating system may comprise a control system. The control system may especially be configured to control the light sources.

The control system may also be configured to receive and execute instructions from a remote control. In embodiments, the control system may be controlled via an App on a device, such as a portable device, like a Smartphone or I-phone, a tablet, etc. The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, Thread, WIFI, LiFi, ZigBee, BLE or WiMAX, or another wireless technology.

In embodiments, the control system may control in dependence of one or more of an input signal of a user interface, a sensor signal (of a sensor), and a timer. The term “timer” may refer to a clock and/or a predetermined time scheme.

In a further aspect, the invention may provide the triangular light guide panel as such. In a further aspect, the invention may provide the lighting arrangement as such.

In yet a further aspect, the invention also provides a lamp or a luminaire comprising the light generating system as defined herein. The luminaire may further comprise a housing, optical elements, louvres, etc. etc. The lamp or luminaire may further comprise a housing enclosing the light generating system. The lamp or luminaire may comprise a light window in the housing or a housing opening, through which the system light may escape from the housing. In yet a further aspect, the invention also provides a projection device comprising the light generating system as defined herein. Especially, a projection device or “projector” or “image projector” may be an optical device that projects an image (or moving images) onto a surface, such as e.g. a projection screen. The projection device may include one or more light generating systems such as described herein.

Hence, in an aspect the invention also provides a lighting device selected from the group of a lamp, a luminaire, a projector device, a disinfection device, a photochemical reactor, and an optical wireless communication device, comprising the light generating system as defined herein. The lighting device may comprise a housing or a carrier, configured to house or support, one or more elements of the light generating system. For instance, in embodiments the lighting device may comprise a housing or a carrier, configured to house or support one or more of triangular light guide panels.

In a further aspect, the invention may provide an indoor space hosting the light generating system according to the invention, especially a light generating system comprising a plurality of lighting arrangements coupled via (respective) hinge arrangements. In particular, in embodiments, the plurality of lighting arrangements may (be configured to) form a structure comprising a curve defined by four or more lighting arrangements.

Instead of the terms “lighting device” or “lighting system”, and similar terms, also the terms “light generating device” or “light generating system”, (and similar terms), may be applied. A lighting device or a lighting system may be configured to generate device light (or “lighting device light”) or system light (“or lighting system light”). As indicated above, the terms light and radiation may interchangeably be used. The lighting device may comprise a light source. The device light may in embodiments comprise one or more of light source light and converted light source light (such as luminescent material light).

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1A-C schematically depict an embodiment of a light generating system.

FIG. 2A-B schematically depicts aspects of an embodiment of a light generating system.

FIG. 3A-B schematically depict an embodiment of a light generating system comprising a plurality of lighting arrangements functionally coupled via hinge arrangements.

FIG. 4 schematically depicts embodiments of a lighting device and of an indoor space. The schematic drawings are not necessarily to scale.

### DETAILED DESCRIPTION OF THE EMBODIMENTS

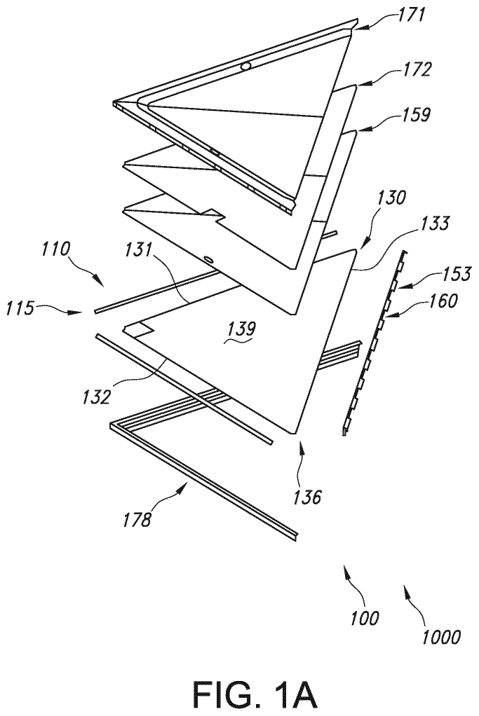

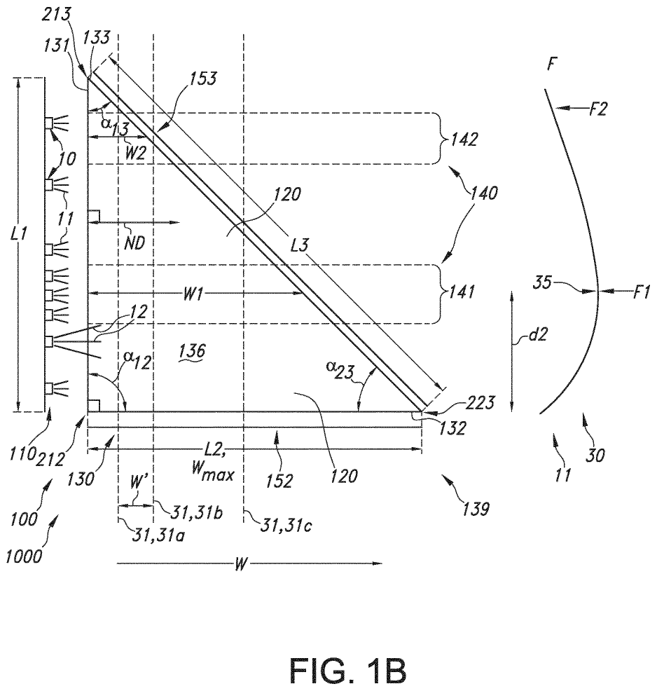

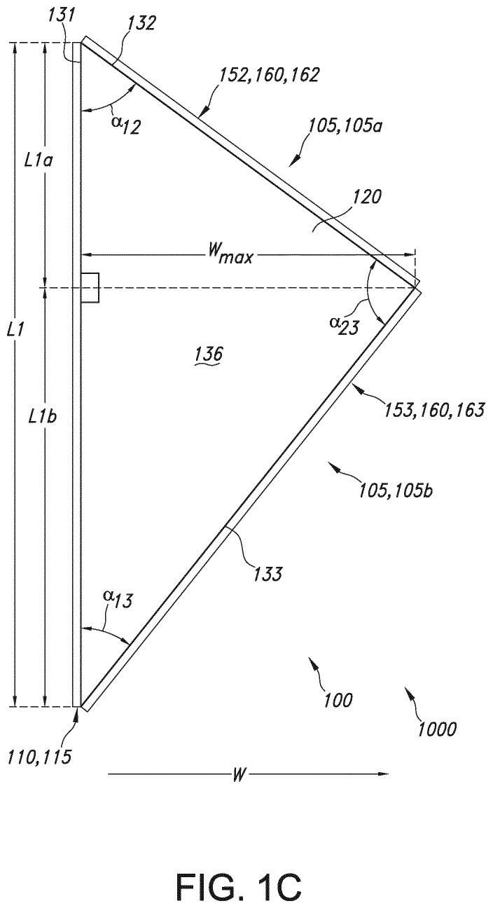

FIG. 1A-C schematically depicts an embodiment of a light generating system 1000 comprising a lighting arrangement 100 of a triangular light guide panel 130 and a light source arrangement 110. In the depicted embodiments, the triangular light guide panel 130 comprises a first triangular face 136 and a second triangular face 139, wherein the first triangular face 136 and the second triangular face are arranged opposite of one another. Further, in the depicted embodiments, the triangular light guide panel 130 further comprises a first side face 131, a second side face 132, and a third side face 133, the side faces 131, 132, 133 all bridging a distance d1 between the first triangular face 136 and the second triangular face 139. The first side face may especially have a first length L1. In particular, the first side face may have a first length L1 along an axis of elongation (of the first side face 131). Further, in the depicted embodiments, the light source arrangement 110 comprises a plurality of light sources 10 configured in an array 115 aligned with the first side face 131, wherein the light sources 10 are configured to provide light source light 11 having a luminous flux. In particular, the light sources 10 may be configured to provide the light source light 11 to the first side face 131, i.e., the first side face 131 may be arranged in a light-receiving relationship with the (plurality of) light sources. The triangular light guide panel 130 may further comprise light outcoupling elements 120, wherein the light outcoupling elements are arranged in the triangular light guide panel 130, on the first triangular face, and/or on the second triangular face. The light outcoupling elements may be configured to facilitate light outcoupling from the triangular light guide panel 130, especially to facilitate light outcoupling via the first triangular face. The lighting arrangement 100, especially the light source arrangement 110 and the triangular light guide panel 130, may be configured such that in a first operational mode of the light generating system 1000 at least part of the light source light 11 enters the triangular light guide panel 130 via the first side face 131 to provide incoupled light source light, especially wherein the triangular light guide panel 130 is configured to guide the incoupled light source light via total internal reflection. Further, the lighting arrangement 100, especially the light source arrangement 110 and the triangular light guide panel 130, may be configured such that in a first operational mode of the light generating system 1000 at least part of the incoupled light source light is coupled out from the triangular light guide panel 130 via the (light outcoupling elements and the) first triangular face 136.

In embodiments, a density of the light outcoupling elements 120 may increase with increasing normal distance ND from the first side face 131, i.e., the density of the light outcoupling elements may increase with increasing distance perpendicular to the first side face.

In further embodiments, in the first operational mode, the light source light 11 incident on the first side face 131 may have a luminous flux gradient along at least 20% of the first length L1.

FIG. 1A further schematically depicts an exploded view of an embodiment of the light generating device. In the depicted embodiment, the light generating device comprises a back plate 171, compression back foam 172, a triangular reflector 159, the triangular light guide panel 130, a (third) side face reflector 153, a hinge arrangement 160, and a side profile 178.

In particular, in the depicted embodiment, the triangular reflector 159 is arranged downstream from the second triangular face 139, and is configured to reflect light source light 11 (back) into the triangular light guide panel 130 via the second triangular face 139.

Further, in the depicted embodiment, the hinge arrangement 160 is arranged at the third side face 133. In further embodiments, the hinge arrangement 160 may (also) be arranged at the first side face 131 or at the second side face 132, especially at the second side face 132.

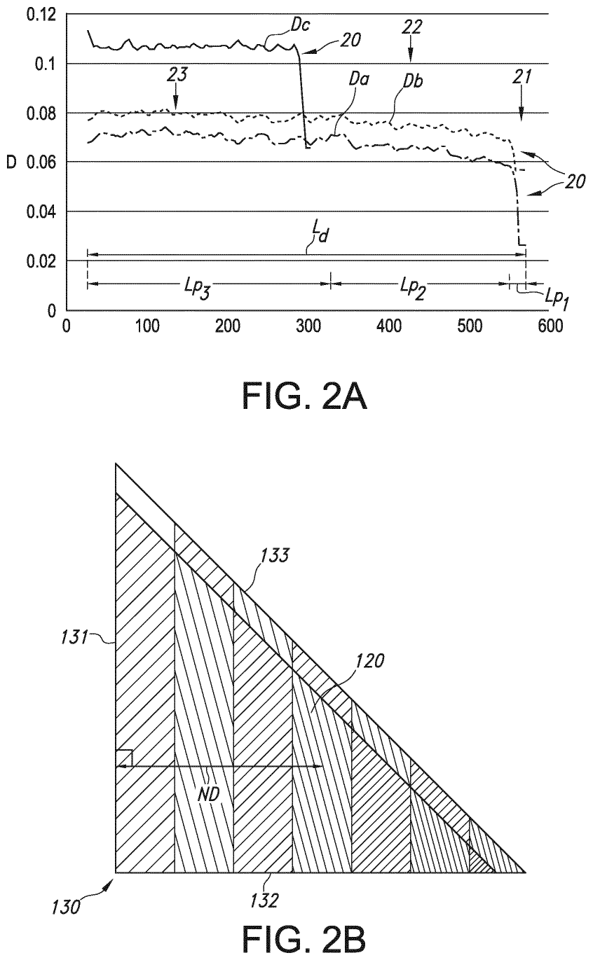

FIG. 1B schematically depicts an embodiment of the light generating system 1000 comprising a (third) side face reflector 153. In the depicted embodiment, the (third) side face reflector 153 is arranged downstream of the third side face 133, and the side face reflector 153 is configured to reflect light source light 11 (back into the triangular light guide panel 130), especially at the third side face 133. Further, a (first) angle α₁₃ between the first side face 131 and the third side face 133 may be <90°, such as ≤60°. In particular, in the depicted embodiment the (first) angle α₁₃ may be (about) 45°. Yet further, in the depicted embodiment, a density of the light outcoupling elements 120 may decrease in a direction parallel to the first side face 131 with decreasing distance to the third side face 133 (also see FIG. 2).

Similarly, in the depicted embodiment, the light generating system 1000 comprises a (second) side face reflector 152, wherein the (second) side face reflector 152 is arranged downstream of the second side face 132, and wherein the (second) side face reflector 152 is configured to reflect light source light 11 (back into the triangular light guide panel 130) at the second side face 132.

FIG. 1B further schematically depicts an embodiment wherein the triangular light guide panel 130 has a right angle between the first side face 131 and the second side face 132. In particular, in the depicted embodiment, a (second) angle α₁₂ between the first side face 131 and the second side face 132 is 90°. In further embodiments, the (second) angle α₁₂ may be <90°or >90°, such as selected from the range of 30°-130°, such as from the range of 50°-120°, especially from the range of 70°-110°, such as from the range of 80° 100°. In general, in embodiments, α₁₂>α₁₃.

In the depicted embodiment, a (third) angle α₂₃ between the second side face 132 and the third side face 133 is 45°. Hence, in the depicted embodiment, the triangular light guide panel 130 has a (first angle) α₁₃ at a first corner 213, a second angle α₁₂ at a second corner 212, and a third angle α₁₃ at a third corner 223, wherein α₁₃ and α₂₃ are 45° and α₁₂ is 90°. Hence, in the depicted embodiment, the triangular light guide panel has a shape according to an isosceles right triangle.

Hence, in FIG. 1B, the first length L1 of the first side face 131 is equal to a second length L2 of the second side face 132. Further, in the depicted embodiment, a third length L3 of the third side face 133 has a length of \sqrt{2}*L1, i.e., about 1.41*L1.

In further embodiments, 0.5≤L1/L2≤2, such as 0.7≤L1/L2≤1.5, especially 0.8≤L1/L2≤1.3, such as 0.98≤L1/L2≤1.02.

In further embodiments, 1.1≤L1/L3≤3, such as 1.2≤L1/L3≤2, especially 1.3≤L1/L3≤1.6, such as 1.4≤L1/L3≤1.45.

As can be seen in FIG. 1B, the triangular light guide panel may have a varying width W perpendicular to the first side face 131. In the depicted embodiment, along the first length L1 the lighting arrangement 100 is sectioned into a plurality of sections 140, including a first section 141 and a second section 142. In particular, the triangular light guide panel 130 has a first average width W1 in the first section 141 and a second average width W2 in the second section 142, wherein W1>W2.

In further embodiments, especially in the operational mode, the light sources 10 may be configured to provide light source light 11 having a first luminous flux F1 to the first section 141 and light source light having a second luminous flux F2 to the second section 142, wherein F1>F2. Hence, the light sources 10 may be configured to provide a higher luminous flux F2 to the wider section.

Referring to FIG. 1b on the right side, Hence, the luminous flux comprises two gradient, having mutual maximum (here about F1), somewhere between larger than 0>L1 and smaller than L1. In one direction, a first gradient increases and a second gradient decreases. The two gradient may be over essentially the entire Length L1.

In further embodiments, along a first width range W′, the triangular light guide panel 130 may have a first (average) density D1 of light outcoupling elements 120 in the first section 141 and a second (average) density D2 of light outcoupling elements 120 in the second section 142, wherein D1>D2. In particular, the first width range W′ may be close to the third side face 133 for the second section 142, whereas for the wider first section 141, the first width range W′ is remote from the third side face.

As mentioned above, the density of the light outcoupling elements 120 may increase with increasing normal distance ND to the first side face 131. Hence, in embodiments, within each section 140 (of the plurality of sections 140) a density D of light outcoupling elements 120 may increase with increasing normal distance ND to the first side face 131.

FIG. 1B further schematically depicts an embodiment wherein, in in the first operational mode, the light source light 11 incident on the first side face 131 has a luminous flux gradient along at least 20% of the first length L1. In particular, FIG. 1B schematically depicts (on the right) a graph of luminous flux F versus position 1 along the first length L1. For visualizational purposes, the graph is depicted aligned with the first side face 131. In the graph 1 runs from the first corner 213 to the second corner 212. In particular, in the depicted embodiment, along the first length L1 the luminous flux varies according to a unimodal distribution 30, wherein the unimodal distribution 30 is skewed, especially towards the first corner 213, i.e., the peak 35 of the luminous flux (or “of the unimodal distribution”) lies closer to the second corner 212 than to the first corner 213.

In further embodiments, the peak 35 of the unimodal distribution is arranged between a distance d2 from the second side face 132, wherein d2 is selected from the range of 0.1*L1-0.45*L1, such as from the range of 0.2*L1-0.4*L1.

In the depicted embodiment, a light source pitch p, especially an LED pitch, in the array 115 varies along the first length L1 to provide the luminous flux varying over at least part of the first length L1, especially to provide the luminous flux gradient. In particular, in the depicted embodiment, along the first length L1 a light source density may vary according to a unimodal distribution 30, wherein the unimodal distribution is skewed towards the first corner 213.

Additionally or alternatively, and especially in the first operational mode, the light generating system 1000 may be configured to vary a current provided to the light sources 10 along the first length L1 to provide the luminous flux variation, especially to provide the luminous flux gradient.

Further, in embodiments wherein the amount of luminous flux incident on the first side face 131 approximates (or follows) a unimodal distribution 30, the light source light 11 incident on the first side face 131 may have two luminous flux gradients running from the peak 35 of the unimodal distribution 30, one of which runs towards the first corner 213 and, one of which runs towards the second corner 212. Hence, in embodiments, the light source light 11 incident on the first side face 131 may have a first luminous flux gradient along at least 20% of the first length L1 and a second luminous flux gradient along at least 20% of the first length L1. In further embodiments, the first luminous flux gradient and the second luminous flux gradient may together cover at least 90% of the first length L1, such as at least 95%.

FIG. 1C schematically depicts an embodiment of a light generating system 1000 with a triangular light guide panel having no right angle. In the depicted embodiment, the triangular light guide panel has a largest width W_{Max} perpendicular to the first side face, i.e., perpendicular to the first length L1, wherein the largest width W_{Max} differs from the second length L2. In embodiments, W_{Max} may be selected from the range of 0.1*L1-10*L1, such as from the range of 0.2*L1-5*L1, especially from the range of 0.5*L1-2*L1. In further embodiments, W_{Max} may be selected from the range of 0.8*L1-1.2*L1, such as from the range of 0.9*L1-1.1*L1.

In further embodiments, such as in FIG. 1B, L1 and W_{Max} may be (essentially) equal. In particular, in FIG. 1B, W_{Max} may be equal to L2.

FIG. 2A schematically depicts an outcoupling element density pattern 20 along three cross-sections 31, 31a, 31b, 31c of the triangular light guide panel 130 of FIG. 1B, which cross-sections 31, 31a, 31b, 31c are parallel to the first side face 131. In particular, in the embodiment depicted in FIG. 1B, the density of outcoupling elements along the cross-sections 31, 31a, 31b, 31c are according to the outcoupling element density patterns shown in FIG. 2A. In particular, FIG. 2A shows the density D (in a.u.) versus the position 1 (in a.u.) along the first length L1 relative to the second corner 212, wherein line Da (of FIG. 2A) corresponds to cross-section 31a (of FIG. 1B), line Db corresponds to cross-section 31b, and line Dc corresponds to cross-section 31c. Hence, as shown in FIG. 2A, the density of the light outcoupling elements 120 may overall increase from cross-section 31a to 31b to 31c, i.e., with increasing normal distance ND to the first side face 131. Further, as shown in FIG. 2A, the density of the light outcoupling elements 120 may decrease with decreasing distance to the third side face 133 in a direction parallel to the first side face 131.

Further, FIG. 2A schematically depicts that the rate of change in density of light coupling elements may be relatively high close to the third side face 133, that the rate of change may be substantially lower a bit removed from the third side face, and that the density may (essentially) fluctuate around a constant value remote from the third side face 133. In particular, in embodiments, the outcoupling element density pattern 20 for a cross-section may have a length L_{d} parallel to the first side face 131. For visualizational purposes in FIG. 2A the length L_{d} is only drawn for cross-section 31a. In the depicted embodiment, the outcoupling element density pattern 20 further comprises a first pattern part 21 and a second pattern part 22, wherein the first pattern part 21 is arranged (directly) between the third side face 133 and the second pattern part 22. In particular, the first pattern part 21 has a first pattern length L_{P1}, wherein 0.03≤L_{P1}/L_{d}≤0.2, wherein in the first pattern part 21 the density of outcoupling elements 120 increases by at least 20% in a direction away from the third side face 133. Further, the second pattern part 22 may have a second pattern length L_{P2}, wherein 0.1≤L_{P2}/L_{d}≤0.5, and wherein in the second pattern part 22 the density of outcoupling elements 120 increases by 5%-15% in a direction away from the third side face 133.

In further embodiments, the outcoupling element density pattern 20 further comprises a third pattern part 23, wherein the third pattern part 23 abuts the second pattern part 22, and wherein the third pattern part 23 has a third pattern length L_{P3}, wherein 0.3≤L_{P3}/L_{d}≤0.8, and wherein in the third pattern part 23 the density of outcoupling elements 120 varies less than 10% from an average density of outcoupling elements 120 in the third pattern part 23.

FIG. 2B schematically depicts a density of the light outcoupling elements 120 arranged in or on an embodiment of the triangular light guide panel 130. In particular, a the changing hatching patterns from left to right and from top to bottom correspond to an increasing density of the light outcoupling elements 120. For visualization purposes, a higher density of the light outcoupling elements 120 is represented by a higher density of hatching lines. Hence, as depicted in FIG. 2B, the density of the light outcoupling elements 120 may, in embodiments (a) increase with increasing normal distance ND from the first side face 131, and may decrease with decreasing distance to the third side face 133 in a direction parallel to the first side face 131. Such a distribution of light outcoupling elements 120 may facilitate providing particularly homogenous system light 1001 from the first triangular face 136.

For visualizational purposes, in the depicted embodiment, the density of the light outcoupling elements 120 substantially decreases at a specific distance (parallel to the first side face 131) from the third side face 133. In further embodiments, the decrease may be more gradual (also see FIG. 2A).

Further, in embodiments, the density of the light outcoupling elements 120 may vary via one or more of a size of the light outcoupling elements 120 or a number of the light outcoupling elements 120.

In further embodiments, the light outcoupling elements 120 may be arranged on the second triangular face 139, especially wherein the at least part of the incoupled light source light is coupled out from the triangular light guide panel 130 via the light outcoupling elements and the first triangular face 136.

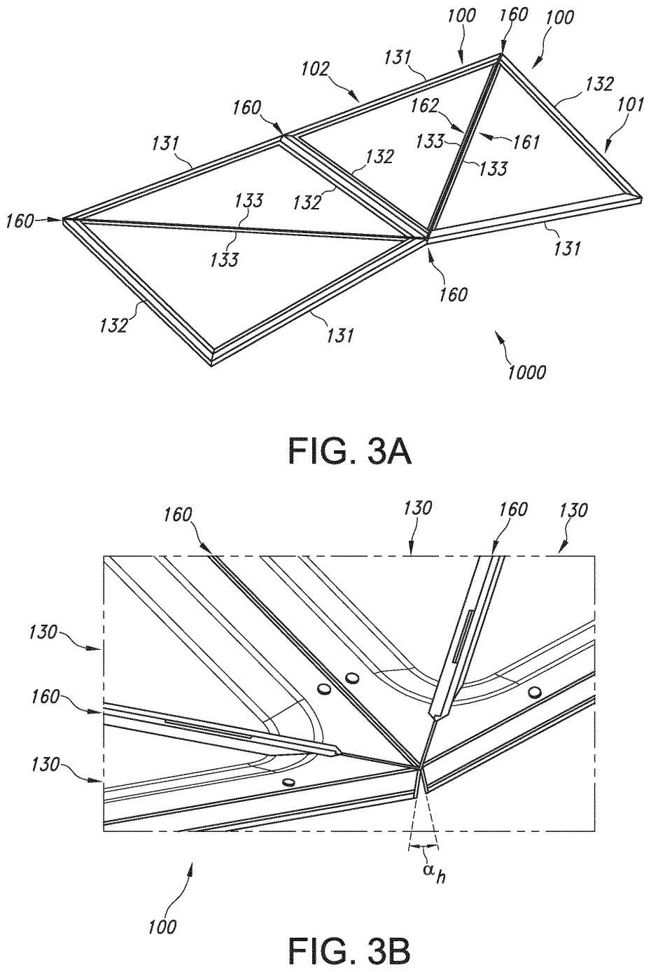

FIG. 3A schematically depicts an embodiment of a light generating system 1000 comprising a plurality of lighting arrangements 100. Specifically, in the depicted embodiment, the light generating system 1000 comprises four lighting arrangements 100, wherein the lighting arrangements 100 are functionally coupled via hinge arrangements 160. In particular (at least) two of the lighting arrangements 100 comprise hinge arrangements 160 at two side faces, i.e., at their second and third faces in the depicted embodiment. In further embodiments, a lighting arrangement may comprise three hinge arrangements 160, especially wherein a hinge arrangement 160 is arranged on each of the side faces.

In further embodiments, the plurality of lighting arrangements 100 comprises at least four lighting arrangements 100 coupled via (respective) hinge arrangements 160. Especially, for at least two sets of two functionally coupled hinge arrangements 160, especially physically coupled hinge arrangements, applies that (a) one of the two functionally coupled hinge arrangements 160 is arranged at the first side face 131 or the second side face 132 of one of the plurality of lighting arrangements 100; and another of the two functionally coupled hinge arrangements 160 is arranged at the first side face 131 or the second side face 132 of another of the plurality of lighting arrangements 100.

Further, in the embodiment depicted in FIG. 3A, the light generating system 1000 comprises a plurality of lighting arrangements 100 comprising a first lighting arrangement 101 and a second lighting arrangement 102. In particular, in the depicted embodiment, a first hinge arrangement 161 is arranged at the third side face 133 of the first lighting arrangement 101, and a second hinge arrangement 162 is arranged at the third side face 133 of the second lighting arrangement 162, and the first hinge arrangement 161 is functionally coupled, especially physically coupled, to the second hinge arrangement 162.

In further embodiments, the first hinge arrangement 161 may be arranged on the first side face 131 or the second side face 132 of the first lighting arrangement 101, especially on the first side face 131, or especially on the second side face 132. Similarly, in embodiments, the second hinge arrangement 162 may be arranged on the first side face 131 or the second side face 132 of the second lighting arrangement 102, especially on the first side face 131, or especially on the second side face 132.

For instance, FIG. 3B schematically depicts a close-up view of lighting arrangements 100 functionally, especially physically, coupled via (respective) hinge arrangements 160, wherein the hinge arrangements 160 are arranged on the second side faces 132 of the first lighting arrangement 101 and of the second lighting arrangement 102. In particular, in the depicted embodiment, the first lighting arrangement 101 and the second lighting arrangement 102 are arranged at a hinge angle αₕ, wherein the hinge angle αₕ is selected from the range of 5°-60°.

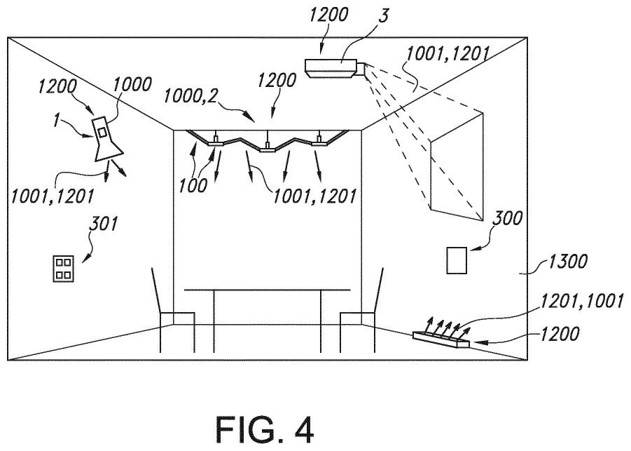

FIG. 4 schematically depicts an embodiment of a luminaire 2 comprising the light generating system 1000 as described above. Reference 301 indicates a user interface which may be functionally coupled with the control system 300 comprised by or functionally coupled to the light generating system 1000. FIG. 3 also schematically depicts an embodiment of lamp 1 comprising the light generating system 1000. Reference 3 indicates a projector device or projector system, which may be used to project images, such as at a wall, which may also comprise the light generating system 1000. Hence, FIG. 3 schematically depicts embodiments of a lighting device 1200 selected from the group of a lamp 1, a luminaire 2, a projector device 3, a disinfection device, a photochemical reactor, and an optical wireless communication device, comprising the light generating system 1000 as described herein. In embodiments, such lighting device may be a lamp 1, a luminaire 2, a projector device 3, a disinfection device, or an optical wireless communication device. Lighting device light escaping from the lighting device 1200 is indicated with reference 1201. Lighting device light 1201 may essentially consist of system light 1001, and may in specific embodiments thus be system light 1001. Reference 1300 refers to a space, especially an indoor space, such as a room.

In particular, FIG. 4 schematically depicts an embodiment of the light generating system 1000, wherein the light generating system comprises a plurality of lighting arrangements 100.

FIG. 4 further schematically depicts an embodiment of the indoor space hosting the light generating system. In the depicted embodiment, the plurality of lighting arrangements 100 form a structure comprising a curve defined by four or more lighting arrangements 100.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage. In yet a further aspect, the invention (thus) provides a software product, which, when running on a computer is capable of bringing about (one or more embodiments of) the method as described herein.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A light generating system comprising a lighting arrangement of a triangular light guide panel and a light source arrangement, wherein:
the triangular light guide panel comprises a first triangular face and a second triangular face, wherein the triangular light guide panel further comprises a first side face, a second side face and a third side face, bridging a distance (d1) between the first triangular face and the second triangular face wherein the first side face has a first length (L1);
the light source arrangement comprises a plurality of light sources configured in an array aligned with the first side face wherein the light sources are configured to provide light source light having a luminous flux, wherein the light sources comprise solid state light sources;
the triangular light guide panel comprises light outcoupling elements, wherein the light outcoupling elements are arranged in the triangular light guide panel and/or on the first triangular face and/or on the second triangular face and wherein the light outcoupling elements are configured to facilitate light outcoupling from the triangular light guide panel;
the light source arrangement and the triangular light guide panel are configured such that in a first operational mode of the light generating system (a) at least part of the light source light enters the triangular light guide panel via the first side face to provide incoupled light source light wherein the triangular light guide panel is configured to guide the incoupled light source light via total internal reflection, and (b) at least part of the incoupled light source light is coupled out from the triangular light guide panel via the first triangular face;
a density of the light outcoupling elements increases with increasing normal distance (ND) from the first side face; and
in the first operational mode, the light source light incident on the first side face has a luminous flux gradient along at least 20% of the first length (L1).

2. The light generating system according to claim 1, wherein the density of the light outcoupling elements varies in a cross-section parallel to the first side face.

3. The light generating system according to claim 2, wherein the light generating system comprises a side face reflector wherein the side face reflector is arranged downstream of the third side face, and wherein the side face reflector is configured to reflect light source light, wherein an angle (α₁₃) between the first side face and the third side face is selected from the range of <90°, and wherein the density of the light outcoupling elements decreases in a direction parallel to the first side face with decreasing distance to the third side face.

4. The light generating system according to claim 3, wherein the triangular light guide panel has an outcoupling element density pattern along a cross-section of the triangular light guide panel wherein the cross-section is parallel to the first side face wherein the outcoupling element density pattern has a length (Ld) parallel to the first side face and wherein the outcoupling element density pattern comprises a first pattern part and a second pattern part, wherein the first pattern part is arranged between the third side face and the second pattern part, wherein:
the first pattern part has a first pattern length (L_{P1}), wherein 0.03≤L_{P1}/L_{d}<0.2, wherein in the first pattern part the density of outcoupling elements increases by at least 20% in a direction away from the third side face; and
the second pattern part has a second pattern length (L_{P2}), wherein 0.1<L_{P2}/L_{d}≤0.5, and wherein in the second pattern part the density of outcoupling elements increases by 5%-15% in a direction away from the third side face.

5. The light generating system according to claim 4, wherein the outcoupling element density pattern further comprises a third pattern part, wherein the third pattern part abuts the second pattern part and wherein:
the third pattern part has a third pattern length (L_{P3}), wherein 0.3<L_{P3}/L_{d}<0.8, wherein in the third pattern part the density of outcoupling elements varies less than 10% from an average density of outcoupling elements in the third pattern part.

6. The light generating system according to claim 1, wherein the triangular light guide panel has a varying width (W) perpendicular to the first side face wherein along the first length (L1) the lighting arrangement is sectioned into a plurality of sections wherein:
the plurality of sections include a first section and a second section
the triangular light guide panel has a first average width (W1) in the first section and a second average width (W2) in the second section, wherein W1>W2; and
in the operational mode the light sources are configured to provide light source light having a first luminous flux (F1) to the first section and light source light having a second luminous flux (F2) to the second section wherein F1>F2.

7. The light generating system according to claim 6, wherein:
along a first width range (W′), the triangular light guide panel has a first density D1 of light outcoupling elements in the first section and a second density D2 of light outcoupling elements in the second section wherein D1>D2.

8. The light generating system according to claim 1, wherein the density of the light outcoupling elements varies via one or more of (i) a size of the light outcoupling elements and (ii) a number of the light outcoupling elements; and wherein the light outcoupling elements are arranged on the second triangular face, wherein the at least part of the incoupled light source light is coupled out from the triangular light guide panel via the light outcoupling elements and the first triangular face.

9. The light generating system according to claim 1, wherein along the first length (L1) the luminous flux varies according to a unimodal distribution wherein the first side face shares a corner with the third side face and wherein the unimodal distribution is skewed towards the corner.

10. The light generating system according to claim 1, wherein the triangular light guide panel has a right angle between the first side face and the second side face, and wherein the second side face has a second length (L2), wherein 0.98≤L1/L2≤1.02.

11. The light generating system according to claims 1, wherein a light source pitch (p) in the array varies along the first length (L1), to provide the luminous flux gradient.

12. The light generating system according to claim 1, wherein the light generating system comprises a plurality of lighting arrangements comprising a first lighting arrangement and a second lighting arrangement, wherein a first hinge arrangement is arranged at the third side face of the first lighting arrangement and wherein a second hinge arrangement is arranged at the third side face of the second lighting arrangement wherein the first hinge arrangement is functionally coupled to the second hinge arrangement.

13. The light generating system according to claim 12, wherein the first lighting arrangement and the second lighting arrangement are arranged at a hinge angle (αₕ), wherein the hinge angle (αₕ) is selected from the range of 5°-60°.

14. The light generating system according to claim 1, wherein the plurality of lighting arrangements comprises at least four lighting arrangements coupled via hinge arrangements wherein for at least two sets of two functionally coupled hinge arrangements applies that
one of the two functionally coupled hinge arrangements is arranged at the first side face or the second side face of one of the plurality of lighting arrangements
another of the two functionally coupled hinge arrangements is arranged at the first side face or the second side face of another of the plurality of lighting arrangements.

15. An indoor space hosting the light generating system according to claim 12, wherein the plurality of lighting arrangements form a structure comprising a curve defined by four or more lighting arrangements
